(19) United States
(12) Patent Application Publication
(10) Pub. No.: US 2007/0173331 A1
(43) Pub. Date: Jul. 26, 2007

(54) METHOD OF RESERVING A SEAT AT A GAMING TABLE

(76) Inventors: James T Crawford III, Charlotte, NC (US); Gehrig Henderson White, Charlotte, NC (US); Hal Jerome Shinn III, Charlotte, NC (US); Kendal Boyd Ferner, Charlotte, NC (US); Jonathan Copley Hamlin, Tega Cay, SC (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 11/565,931

(22) Filed: Dec. 1, 2006

Related U.S. Application Data
(60) Provisional application No. 60/741,191, filed on Dec. 1, 2005.

(51) Int. Cl. A63F 9/24

(52) U.S. Cl. 463/42

(57) ABSTRACT

A method is provided for filling a vacancy at a gaming table with a first new player. An electronic waiting list is managed for filling the vacancy at the gaming table by providing a remote device access to the electronic waiting list via a queue interface. The first new player is allowed to select the electronic waiting list using the remote device and place themselves on the electronic waiting list for the gaming table via the remote device.

### RELATED APPLICATIONS

This application claims the benefit U.S. Provisional Patent Application Ser. No. 60/741,191 filed Dec. 1, 2005, which is hereby incorporated by reference, and is related to U.S. Ser. No. ______, filed on the same date as this application and entitled “Queuing System and Method for a Gaming Table,” having attorney docket no. 060667.00070, and is related to U.S. Ser. No. ______, filed on the same date as this application and entitled “Method of Managing Players on Electronic Waiting Lists,” having attorney docket no. 060667.00071, which are both hereby incorporated by reference.

### FIELD OF THE INVENTION

The present invention relates generally to a system and method for reserving a seat at a gaming table. More specifically, the present invention relates to a system and method for establishing an electronic waiting list for new players interested in playing at a poker table.

### BACKGROUND OF THE INVENTION

Gaming is an increasingly popular form of entertainment. Games, particularly games of chance and skill in which one or more players play and place wagers on the outcome thereof may be played in a variety of ways, including at a casino or other venue. Of the various forms of games which are available for play, many are played with playing cards. Of these, poker is arguably the most popular.

Traditionally, poker is played in a poker room in which a plurality of players are seated at a plurality of poker tables with the players wagering paper, coin money or chips on a series of playing cards dealt from a deck of fifty-two cards. Given the significant interest in playing poker, many poker rooms are consistently at capacity. To efficiently seat new players at the poker tables, the casino or venue often employs a queuing system to establish a waiting list of new players to fill vacant seats at the poker tables.

An example of a queuing system is available from QueueOS, LLC™. A typical queuing system establishes an electronic waiting list. In use, a new player, either acting at an electronic kiosk or through a human host, in the casino places their name on the electronic waiting list. Once their name is on the electronic waiting list, another casino employee visually monitors the seats at the poker tables. Once a vacancy is found, the human host is notified of the vacancy, and the human host assigns the next new player listed on the electronic waiting list to the vacancy. Once the next new player is assigned to the vacancy, the next new player is alerted of the vacancy and offered the vacant seat.

Unfortunately, the new player must be present at the casino and locate an electronic kiosk or human host in order to place their name on the electronic waiting list. As a result, there is a need in the art for a system that is capable of allowing a new player to place their name on the electronic waiting list while they are not necessarily present in the casino.

The present invention is aimed at one or more of the problems set forth above.

### SUMMARY OF THE INVENTION

In a first aspect of the invention, a method of filling a vacancy at a gaming table with a first new player using a remote device is provided. The method provides the steps of managing an electronic waiting list for filling a vacancy at a gaming table and allowing the first new player to select the electronic waiting list using the remote device. The first new player is placed on the electronic waiting list for the gaming table via the remote device.

In a second aspect of the invention, a system for filling a vacancy at a gaming table with a first new player is provided. The system includes a plurality of seats for use by a plurality of current players at the gaming table and a queuing system for managing a first electronic waiting list for filling the vacancy at the gaming table. A queue interface provides the first new player access to the queuing system via a remote device to place the first new player on the first electronic waiting list.

In a third aspect of the invention, a method of filling a vacancy at a gaming table with a first new player is provided. The method includes the steps of managing a first electronic waiting list for filling a vacancy at a first plurality of gaming tables and managing a second electronic waiting list for filling a vacancy at a second plurality of gaming tables. The remote device is provided access to the electronic waiting list via a queue interface. The first new player is allowed to select one of the first and second electronic waiting lists using the remote device. The first new player is placed on the selected one of the first and second electronic waiting lists via the remote device.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a diagrammatic illustration of a plurality of manual and electronic gaming tables in a casino;

FIG. 2A is a perspective view of one of the manual gaming tables;

FIG. 2B is a perspective view of one of the electronic gaming tables;

FIG. 3 is a top view of the electronic gaming table of FIG. 2B;

FIG. 4 is a is a plan view of a player interface of an electronic player interaction area of the system with player's cards hidden;

FIG. 5 is a plan view of the player interface of FIG. 4 with the player's cards revealed;

FIG. 6 is a perspective view of the electronic player interaction area embodied in a stationary module;

FIG. 7 is a perspective view of the electronic player interaction area embodied in a hand-held module;

FIG. 8 is a front and back view of an electronic playing card;

FIG. 9 is a block diagram of the gaming system with a game computer coupled to one electronic poker table;

FIG. 10 is a block diagram of the gaming system with the game computer coupled to a plurality of electronic poker tables;

FIG. 11A is a perspective view of a dealer interface;

FIG. 11B is a representation of a display on the dealer interface;

FIG. 12A is a block diagram of a queuing system of the present invention;

FIG. 12B is a second block diagram of the queuing system of FIG. 12A;

FIG. 12C is a perspective view of a poker room equipped with the queuing system of the present invention;

FIG. 12D is a block diagram of a method of filling a vacancy at a gaming table according to one embodiment of the present invention;

FIG. 12E is a second block diagram of the method of FIG. 12D;

FIG. 12F is a representation of a first screen shot displayed on a queue interface of the queuing system;

FIG. 12G is a representation of a display of the queuing system; and

FIG. 13 is a block diagram of the queuing system showing a remote device connected to the queuing system via a network.

### DETAILED DESCRIPTION OF THE INVENTION

Referring to the Figures, wherein like numerals indicate corresponding parts throughout the several views, a method and system for filling a vacancy at a gaming table 18 are shown.

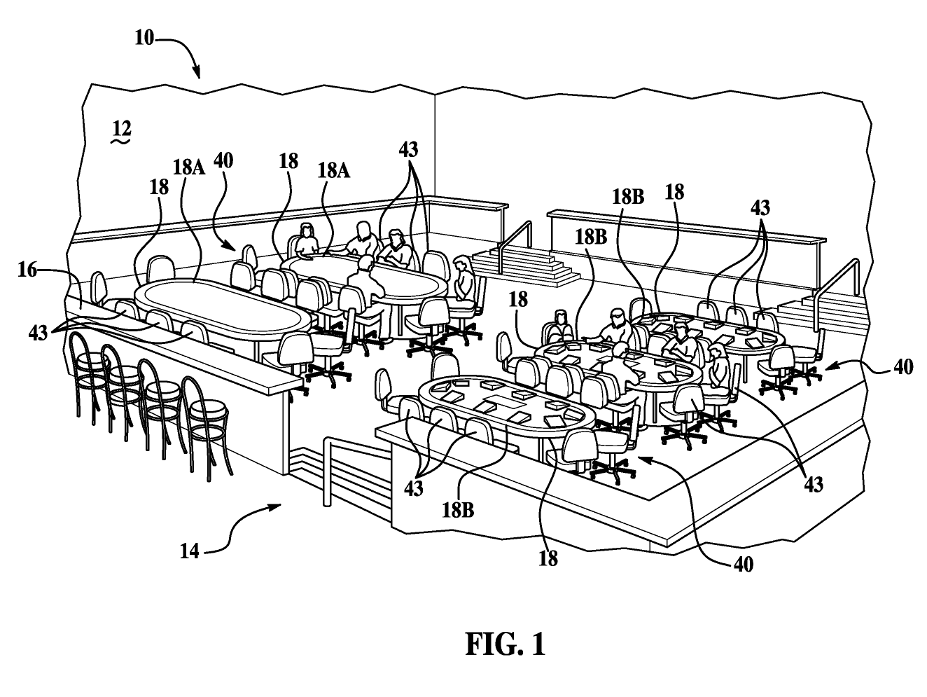

The method is implemented with a gaming system that includes at least one gaming table 18. A plurality of gaming tables 18 can be situated in a gaming environment, such as a casino. The casino may be divided into specialized or designated areas such as a poker room or poker area each containing a plurality of gaming tables 18, as shown in FIG. 1. Poker areas 14 in casinos 12 are often cordoned off by, for example, a railing 16; however, this separation from other gaming in the casino is not necessary for implementation of the system and method. Furthermore, the casino 12 is only one example of a suitable environment for implementation of the system 10 and the present invention is not limited to any such location or environment as will be discussed below.

The method of the present invention may be implemented, in a second embodiment, without utilizing gaming tables 18. Specifically, the system 10 may be based on a network of computing devices (not shown), such as the Internet. In the second embodiment, players do not assemble at a casino, but rather each player utilizes one of the computing devices to access one or more central server computers (not shown), which control play of the game. However, for purposes of clarity, the present invention will be described hereafter in terms of the first embodiment, utilizing at least one electronic gaming table 18B. This description, of course, should not be read to limit the scope of the present invention.

As stated above, the gaming system 10 of the first embodiment includes at least one gaming table 18. The gaming table 18 utilizes cards 76 and/or chips 64 for wagering to provide a card game for play by one or more players. It should be noted that the description that follows is directed toward utilizing both cards 76 and chips 64. However, the system 10 may also provide a non-wagering card game that doesn't utilize chips. The gaming tables 18 may be a manual gaming table 18A, an electronic gaming table 18B, or a combination thereof. If the gaming table 18 is a manual gaming table 18A, then a human dealer is required to perform dealer functions. A human dealer is not required with the electronic gaming table 18B since the system 10 handles all dealer functions. However, those skilled in the art realize that a human dealer could be utilized in conjunction with one of the electronic gaming tables 18 to help facilitate play of the game. Additionally, electronic cards and chips are used at the electronic gaming table 18B. For the purposes of illustration, the gaming table 18 may be illustrated as presenting a poker game known as Texas Hold'em. However, the present invention is not limited to any particular variety of poker or other card game.

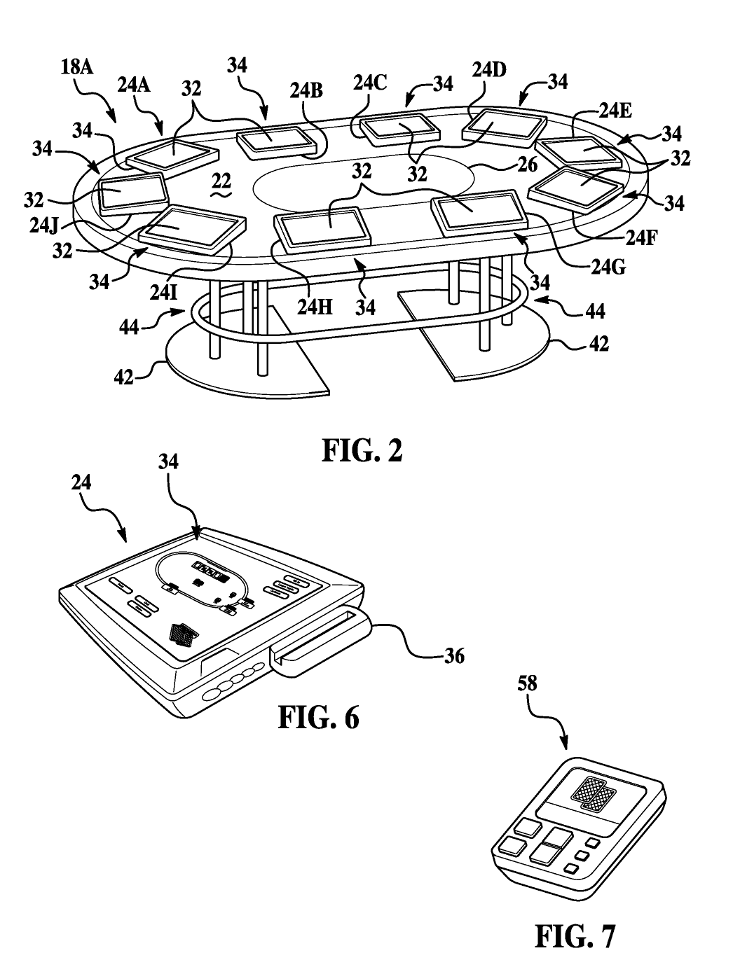

Referring generally to FIG. 2, each gaming table 18 has a table top 20 supported by at least one base 42 at floor level, and a plurality of substantially vertical legs 44 projecting between the base 42 and the table top 20. The table top 20 includes a playing surface 22 and a plurality of seats 43 surrounding the table top 20. For example, each table 18 is capable of seating a maximum of ten players, hence, each table includes ten seats 43. Of course, variations in the number of seats 43 may be contemplated by those skilled in the art. The playing surface 22 may include a central area 55 and the seats 43 are located about the periphery of the gaming table 18 for view by the current players. A player interface 54, corresponding to one of the seats 43 at each electronic gaming table 18B, is disposed at each electronic gaming table 18B and at least one dealer interface 57, corresponding to at least one of the seats 43 at the manual gaming table 18A, is disposed at each manual gaming table 18A. The player interface 54 and dealer interface 57 will each be described in more detail below.

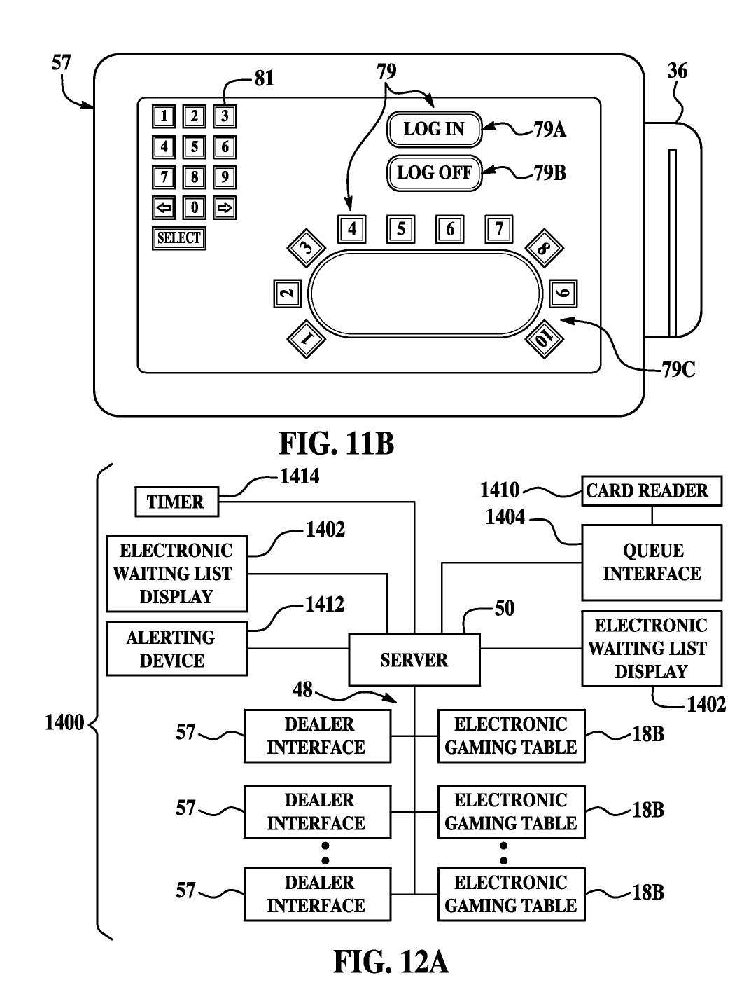

At the manual gaming table 18A, the central area 55 is used to display common cards 30. For example, the central area 55 is advantageous when playing a poker game that uses common cards, such as Texas Hold'em, or a player versus dealer game, such as Blackjack. The playing surface 22 and the central area 22 may be covered in a traditional material such as felt having any variety of colors. Moreover, logos, game information or other information may be printed on the material. At the manual gaming table 18A, standard or authentic playing cards and/or poker chips may be used. Additionally, a dealer may be located at each manual gaming table 18A for dealing cards. The dealer interface 57 at the manual gaming table 18A may be a touch-screen display 54 for use by the dealer. At the manual gaming tables 18A, the dealer interface 57 is used by the dealer to effectuate interaction or input from the player to the system 10, e.g., to log the players into a seat 43 at that gaming table 18. In another embodiment, the dealer interface 57 is used by the individual players to log the players into and/or out of their respective seats 43. It should be appreciated that there may be more than one dealer interface 57 at each of the manual gaming tables 18A as each seat 43 may include a dealer interface 57. The dealer interface 57 may be a hand held module or a module which is built into the manual gaming table 18A. The dealer interface 57 includes a display for inputting information, as shown in FIGS. 11A and 11B. The display may be a touch screen display. However, buttons may also be used. The dealer interface 57 may also include a card reader 36 for reading a player tracking card (not shown). The dealer “logs in” the player to the gaming system 10 through the dealer interface 57 by sliding the card through the card reader 36. This allows the system 10 to identify the player and record their identity. The dealer interface 57 may also (or alternatively) require entry of a personal identification number into an attached keypad or virtual keypad displayed on the dealer interface 57. Alternatively, or in addition, the player may log-in through the dealer interface 57 using a biometric parameter, such as a fingerprint, sensed by a sensor and a RFID card or chip. Once a player's identity is established, the dealer, or player, can access a required player account and purchase chips using an account balance communicated over a network. The player account may have an associated balance that contains a dollar amount based on an amount of money deposited by the player and/or any winnings that they have collected, either through poker or some other game. Additionally, information regarding the player's play at the table 18 may be tracked and recorded.

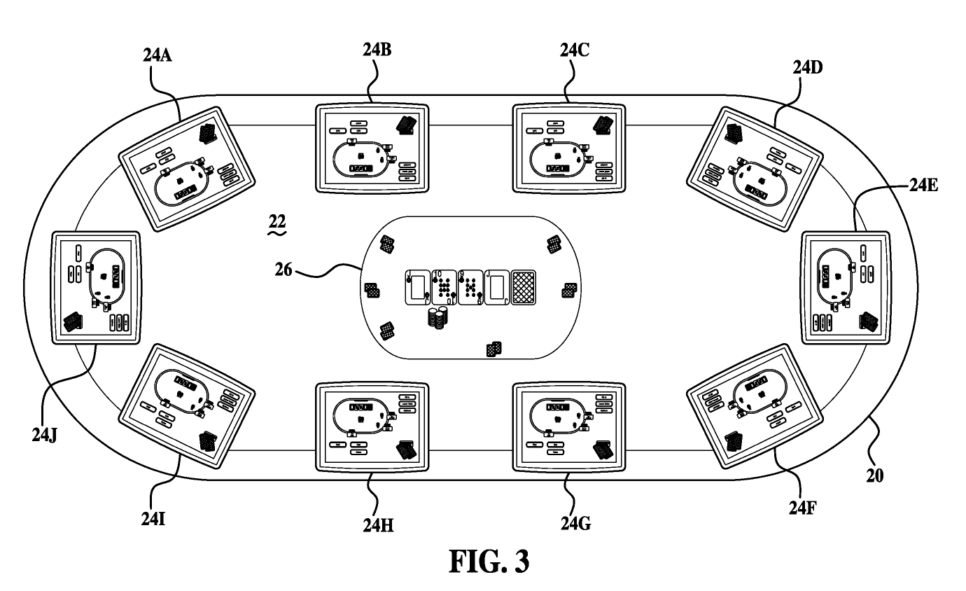

At the electronic gaming table 18B, the seats 43 include a plurality of electronic player interaction areas (EPIA) 24 located around the periphery of the table top 20. If each table includes ten seats 43, each table includes ten EPIAs 24A-24J. Of course, variations in the number of EPIAs 24 may be contemplated by those skilled in the art. Referring to FIG. 3, the central area 55 of the table top 20 may be a central or common display area (CDA) 26 for the display of the common cards 30. Although the EPIA's 24 and CDA 26 are generally computer generated visual displays, thus authentic playing cards are not utilized, the electronic gaming tables 18B of the gaming system 10 are aesthetically designed to convey and retain the overall sense and ambience of a standard poker room with non-electrical poker tables. The playing surface area which is not taken up by the EPIA's 24 and the CDA 26 may be covered in a traditional material such as felt having any variety of colors. Moreover, logos, game information, or other information may be printed on the material. Alternatively, the EPIA's 24 and the CDA 26 is a single display that covers a substantial portion or all of the table top 20. The EPIA's 24 and the CDA 26 can be set apart from the rest of the table top 20 by virtual or computer generated borders. The areas of the display around the EPIA's 24 and the CDA 26 may be used to simulate the playing surface 22 of a standard poker table by, for example, providing an electronic image of a felt material. Furthermore, logos, game information, other information, advertisements, announcements, pictures, videos, or other information may be displayed and rotated, cycled, or shown for a limited period of time on the table top 20.

Referring again to FIG. 2, the player interface 54 may be incorporated into each of the EPIA 24 for the electronic gaming table 18B and is used to convey game information directly to a player and to effectuate interaction or input from the player to the system 10. (Although the touch-screen display and the player interface 54 are both numbered 54, this should not be read as limiting, as those skilled in the art realize other suitable implementations of the player interface 54 other than the touch-screen display). The player interface 54 of the EPIA 24 may be a touch-screen display 54.

Each EPIA 24 can be part of one large display monitor (not shown), such as a LCD or plasma monitor, that includes the CDA 26, or the EPIA's may have separate and distinct monitors and computers networked together as required to play the game. The player interfaces 54 may each be implemented as part of a module 34, as shown in FIG. 2 and in detail in FIG. 6. Alternatively, the player interface 54 may be implemented as part of a hand-held device 58, such as a personal digital assistant (PDA), as shown in FIG. 7 or a cellular telephone.

As stated above, for electronic gaming tables 18B, each touch-screen display 54 may be housed in respective modules 34. Each EPIA 24 may include a fully-functional computer which is also housed in its respective module 34. Thus, the EPIA 24 is easily removable and replaced from the electronic gaming table 18B by simply replacing the entire module 34. The computer includes a processor capable of running an operating system, such as Windows XP or Windows CE, both available from Microsoft Corporation of Redmond, Washington. Alternatively, the EPIA's 24 may be driven by one or more computers (not shown) located in the proximity of the table 18 or within the table 18.

The modules 34 may be removably mounted to the table top 20. The touch-screen display 54 may be mounted substantially parallel and relatively flush with the playing surface 22 of the table top 20. Moreover, the playing surface 22 of the table top 20 can be an overlay with selected cut-outs or openings for exposing the touch-screen display. In this case, the overlay may cover the outer edge of the touch-screen display 54 for aesthetic appearances. Moreover, the touch-screen display 54 can be mounted at an angle with respect to the table top 20 and below the playing surface 22 thus partially shielding the player's cards 28 from adjacent players. Alternatively, and as shown in FIG. 2, the touch-screen display 54 can be mounted at an angle with respect to and above the table top 20. The angle of the touch-screen display 54 can be adjustable for player viewing convenience.

Referring again to FIG. 6, the module 34 may have a card reader 36 for reading a player tracking card. Alternatively, the card reader 36 may be integrated into the bezel (not shown) located around the module 34. A player may “log in” to the gaming system 10 through the EPIA 24 by swiping the card through the card reader 36. This allows the system 10 to identify the player and record their identity. The EPIA 24 may also (or alternatively) require entry of a personal identification number into an attached keypad or virtual keypad displayed on the player interface 54. Alternatively, or in addition, the player may log-in using a biometric parameter, such as a fingerprint, sensed by a sensor and a RFID card or chip. Once a player's identity is established, the player can access a required player account and purchase chips using an account balance communicated over a network. The player account may have an associated balance that contains a dollar amount based on an amount of money deposited by the player and/or any winnings that they have collected, either through poker or some other game. Additionally, information regarding the player's play at the table 18 may be tracked and recorded.

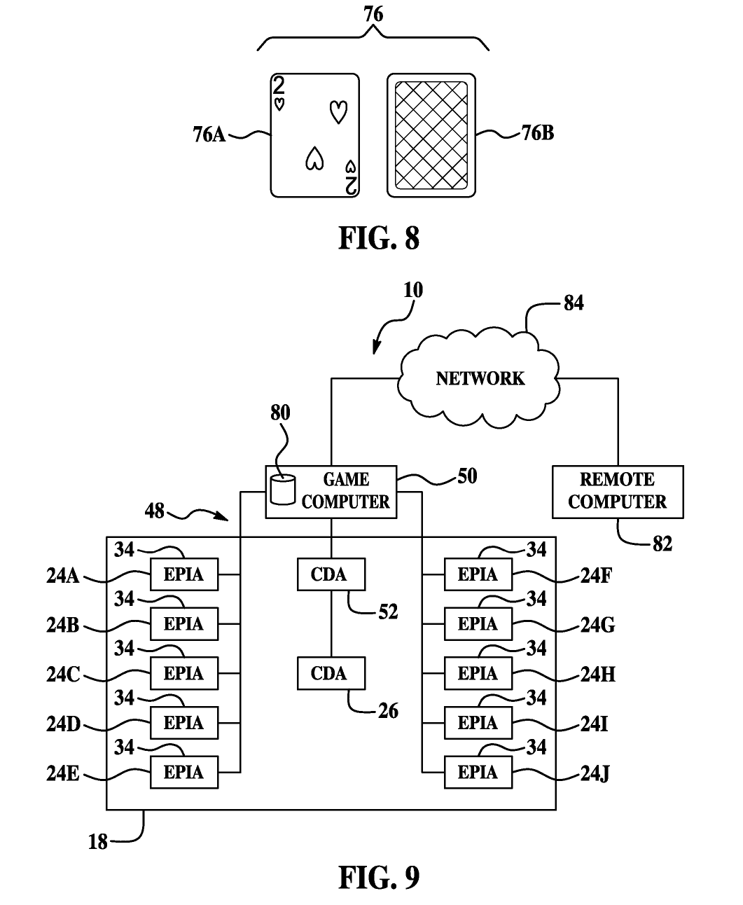

As stated above, the gaming table 18 utilizes cards 76, i.e., authentic or electronic. As best shown in FIG. 8, each card has a front side 76A and a back side 76B. The back side 76B of each card 76 has an identical pattern or image such that the cards cannot be individually identified with respect to any other card when viewing the back side 76B. The playing card 76 may be one of a set or deck of standard playing cards. The deck may be a standard deck of fifty-two cards, with each card having an individual designation. The designations have a first component being assigned values of two through Ace, and the second component being four groupings or suits (hearts, diamonds, clubs, spades). The value and suit of each card is indicated on the front side 76A of each playing card 76. For the electronic playing cards, the image displayed on the back side 76B of the playing cards may be a logo, a random image (chosen from a set of predetermined images), or may be advertising directed at the player. The image may include a video or a cycling through of a set of predetermined images. Alternatively, the image may be selectable by either a player or an employee of a casino 12.

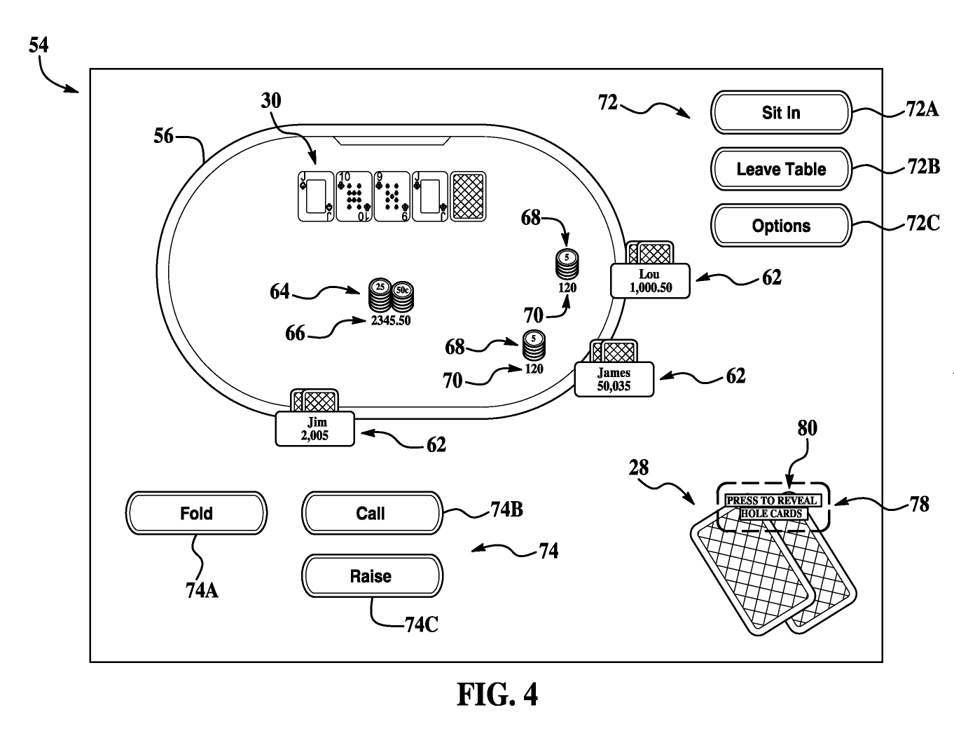

Each player at the gaming table 18 is dealt a number of cards 76, i.e., manually or electronically, hereafter referred to as player's cards 28. In Texas Hold'em, as shown in FIG. 3-4, these player's cards 28 consist of two cards which are dealt face down and are commonly known as “hole cards”. The player's cards 28 are dealt in front of the seats 43 of the respective player at the manual gaming tables 18A or are generally shown directly in front of the respective players on the EPIA 24 when playing at the electronic gaming table 18B. The common cards 30 (or dealer's cards, depending on the game) are displayed in the central area 55 of the playing surface. At the electronic gaming table 18B, the central area 55 may be the CDA 26 and the common cards 30 are displayed ont eh CDA 26. In Texas Hold'em, these common cards 30 are shown face-up in the central area 55. Specifically, three common cards 30 (“the flop”) are dealt at one time, then, another common card 30 (“the turn”) is dealt, and then a fifth common card 30 (“the river”) is revealed. A player's hand consists of the player's cards 28 and the common cards 30. Betting may occur before each distribution of common cards 30 and after all the common cards 30 dealt. At the end of play of a particular round, whichever player holds the highest poker hand is the winner of that round of Texas Hold'em poker.

The gaming tables 18 may be capable of playing any variety of card games. Therefore, the playing cards 76 may be used in any sort of card game and even in such games where the player chooses when to reveal their cards 28 to themselves or to the other players. Each card game, whether poker or otherwise, will generally have its own set of rules, including the number of cards, how the cards are dealt, the number of betting rounds, the structure of permissible wagers, and the like. Thus, while the present invention may be described below in the context of a poker game (and more specifically, with respect to a player's cards 28 in a Hold'em style poker game), the present invention is not limited to such a card game.

Furthermore, the poker or card game can be a timed game, i.e., the players have a predetermined time period to complete each turn. For example, the players have a set period of one minute to complete each turn, or, the period of time may vary. For instance, the first turn may have a period of completion of one minute, while the second turn may have a shorter or longer period of completion. During a given betting round, the players have a predetermined period of time to either fold, call, check, or make a wager. If no action is taken during the predetermined time period, a default action may be taken where the player must fold or check. Generally, the time period for response during a betting round will decrease as the round of the poker game progresses. Parameters, such as the predetermined time period for each betting round may be automatically modified.

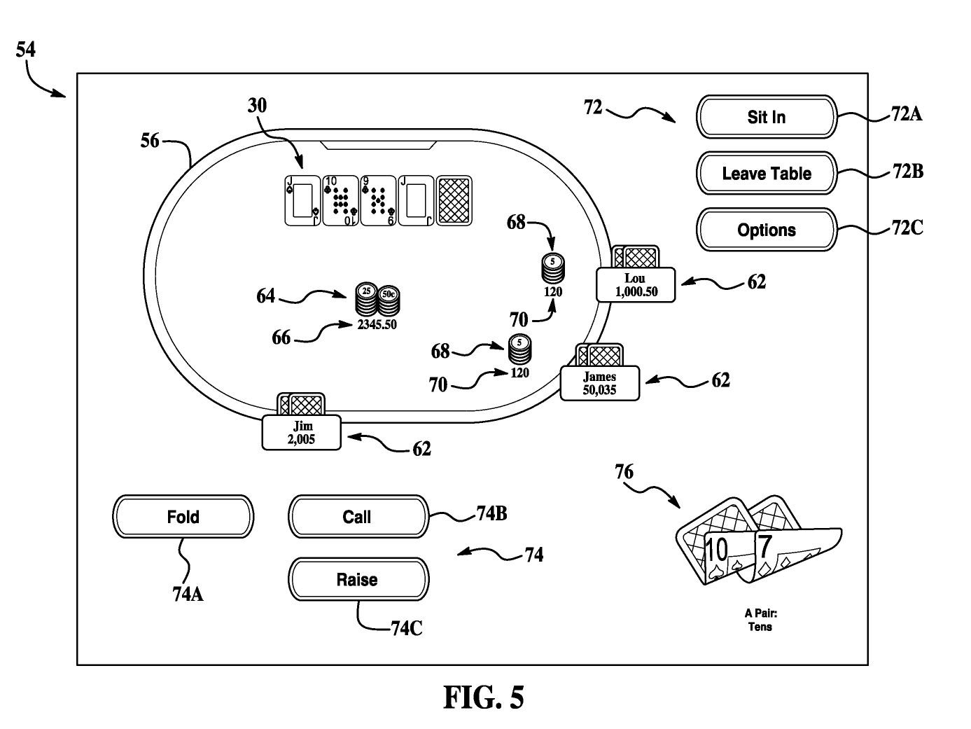

In a traditional card game of Texas Hold'em played with physical cards, the player's cards are dealt “face-down” so that they are not revealed to any other player. The dealt player must then discretely view their own cards without revealing them to other players. To do this, the player may lift the cards close to their bodies, fanning them out, and shielding them with their hands, so only the dealt player can see the front side of their cards. Alternatively, the dealt player may leave the cards face down on the table and lift one side or corner revealing at least a portion of the front side, while shielding the cards with their hands. Similarly, and with electronic player's cards 28, as best shown in FIG. 5 and 6, lifting of the corners of the cards 28 can be computer simulated upon a triggering event initiated by the respective player, such as touching a reveal cards area 78 on the touch-screen display 54.

Referring again to FIG. 5 and 6, the player interface 54 may include a graphical representation 56 of a poker table with each player in the poker game represented by a user graphic 62 (or icon) that lists their name. At the electronic gaming table 18B, the player interface 54 may additionally display each players chip totals and the pot of the current round may be represented in the center of the graphical representation 56 of the poker table by stack(s) of chips 64 and/or a number 66 representing the value of the current pot. Each player's contribution to the pot may be represented by stack(s) of chips 64 and/or a number 66 adjacent their user graphic 62. The player interface 54 may also display the community cards 30. Other information that can be displayed on the player interface 54 include, but is not limited to, an indication (visual icon and/or audio) of the player whose turn it is to act, a total of chips for each player, any cards of the other players that are face-up, and/or messages to the player, such as advertising.

In addition to controllably displaying and/or obscuring a player's hole cards, the player interface 54 may be configured at the electronic gaming table 18B to provide an indication of the player's current highest hand based on the player's cards 28 and the community cards 30 that have been revealed. The highest hand may be shown textually, e.g., two-pairs, and/or graphically, pictures of the five cards which make up the highest hand. Additionally, the player interface 54 may also be configured to indicate the best possible hand (not shown), based on the player's cards 28, the community cards 30 that have been revealed, and the number of community cards 30 that have not been revealed. For example, if the player's cards 28 include two hearts, and the revealed community cards 30 include two hearts, the player interface 54 may indicate that a flush is possible if the remaining community card(s) 30 include a heart.

Referring to FIG. 4 and 5, the player interface 54 may include a series of player buttons 72. The player buttons 72 include, for example, a sit-in button 72A, a leave table button 72B, and an options button 72C. Generally, only one of the sit in button 72A and the leave table button 72B would be active at any time. The options button 72C allows the player to access an option menu or screen (not shown) that allows the player to modify certain parameters of the player interface 54, such as for example, to choose between different formats of the player interface 54 (i.e. graphical display or text display). The player buttons 72 are may be implemented on the touch screen display 54, or alternatively, can be embodied in electromechanical switches or buttons (not shown).

The player interface 54 may also include a series of game buttons 74 for use with the electronic gaming table 18B. The series of game buttons 74 allow the player to signal their game play decisions to the gaming system 10 during the play of the game, and thus may include a fold button 74A, a call button 74B and a raise button 74C. The game buttons 74 are active when it is a player's turn in the poker game and may be inactive when it is not. Moreover, the player interface 54 only activates those buttons 74 that are appropriate, given the rules of the game being played, during the current turn. For example, if the maximum number of raises for a particular game has already been made, then the wager or raise button would be inactive. The raise button 74C may be replaced with one or more buttons (not shown) which allow the player to make a wager of a predetermined or allowed amount, e.g., $10. In addition or alternatively, a keypad (not shown) may be provided which allows the player to key in a wager amount.

Referring to FIG. 11B, the dealer interface 57 may include a series of dealer buttons 77. The dealer buttons include, for example, a plurality of seating buttons 79 and player identity buttons 81. The seating buttons 79 are used by the dealer to select a seat 43 at the manual gaming table 18A. The seating buttons 79 may include a log in button 79A and a log off button 79B for logging a player into or out of a seat 43 and seat select buttons 79C for selecting the particular seat at the manual gaming table 18A for seating the player. The player identity buttons 81 may be used to identify the player being logged on and assigned to a vacant seat or logged off and removed from a seat to create a vacant seat. For example, the player identity buttons 81 may be a keyboard or keypad. However, it should be appreciated that the dealer interface 57 is not limited to this configuration, but may be any configuration desired for seating and unseating a player from a gaming table 18.

The player interface 54 and/or the dealer interface 57 may also provide a player and/or dealer with additional buttons (not shown) that summon or direct specific employees of the casino 12. For example the player or dealer may request a host/hostess to order a drink. Additionally, the dealer may request, or player may anonymously request, that an employee review something that occurred or is occurring at the table 18 (e.g. possible collusion).

Moreover, in the casino 12 environment, a portion of each pot goes to the house for running the poker game. This portion of the pot is known as the rake and may be displayed on each player interface 54. The rake may be shown as an amount in dollars and may include a graphical representation of virtual chips. Similarly, the player interface 54 for the electronic gaming table 18B may display a graphical representation of the chips 64 and/or a dollar amount indicative of the amount of chips 64 each player at the table has remaining and the amount of the current pot.

In addition, or alternatively, to the common cards 30 displayed by the CDA 26, each player interface 54 may include a graphical representation of the community cards in the middle of the graphical representation 56 of the poker table 18. Graphical representations of the other player's card may also be shown (face-down during the current hand and face-up at the end of the hand). The common card 30 displayed in the graphical representation 56 may be smaller than the display of the hole cards 28 for the player of the specific player interface 54. The common cards 30, as displayed in the CDA 26, may appear larger than the common cards 30 displayed in the graphical representation 56 of the player interface 54.

As best illustrated in FIG. 3, the CDA 26 is used to display information such as common cards 30 for all players to see and is thus located further from the players than their respective player interfaces 54. Consequently, the display of the common cards 30 may be larger than the display of the player's cards 28. That is, the player's cards 28 are displayed at a first predetermined ratio from the standard size playing card, and the common cards 30 are displayed at a second predetermined ratio from the standard size playing card. The first and second ratios may be defined such that the common cards 30 are displayed larger than the hole cards 28. Alternatively, the first and second ratios can be the same.

As previously described, the CDA 26 may be separate from the plurality of EPIAs 24, and may be implemented by utilizing an LCD or plasma monitor or similar device. As shown in FIG. 9, a dedicated CDA computer 52 may be implemented to control the CDA 26. The CDA computer 52 may be a “PC” running the Windows XP operating system, although other hardware and software configurations are evident to those skilled in the art. Furthermore, the CDA computer 52 may be a physically separate component from the CDA 26, or integrated together with the CDA 26 in a single package.

The CDA 26 may indicate which player's turn it is and which player is the designated “dealer” for the current hand at the electronic gaming table 18B. These indications are provided by respective visual signals such as an icon, arrow or the like, and/or an audio signal such as a beep, musical tone, and/or voice message. This indication of a player's turn and dealer designation on the CDA 26 may be in addition to the indication provided on the respective EPIA 24.

In some card games, community cards 30 may not exist, hence, during play of these games, the CDA 26 can be used to display advertising messages instead. The advertising messages may be from the casino or third parties and may consist of graphics, pictures, animations, video and/or audio. The advertising may be presented at predetermined locations on the CDA 26 for varied durations as the CDA 26 cycles through a plurality of advertising messages.

In general, the CDA 26, in conjunction with the CDA computer 52. is capable of displaying and/or animating:
blinds,
community cards 30,
bets placed and player chip stacks,
an indication of players who have folded and not folded,
winning hands,
winning hand percentage estimates in situations where all remaining player's cards 28 are exposed, and
rake in dollars or virtual chips.

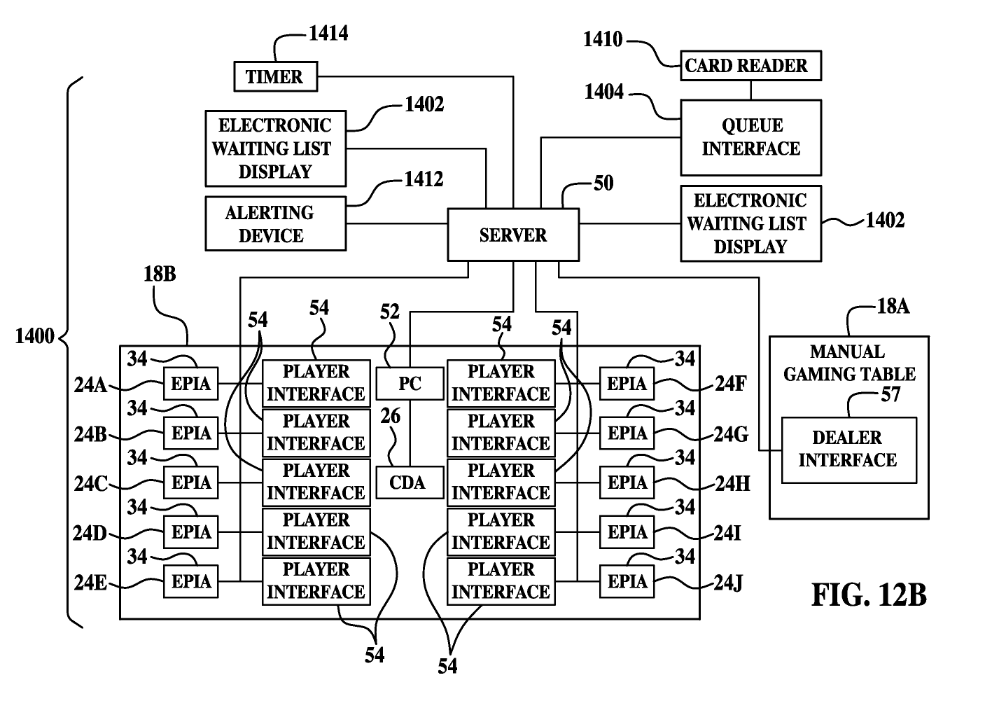

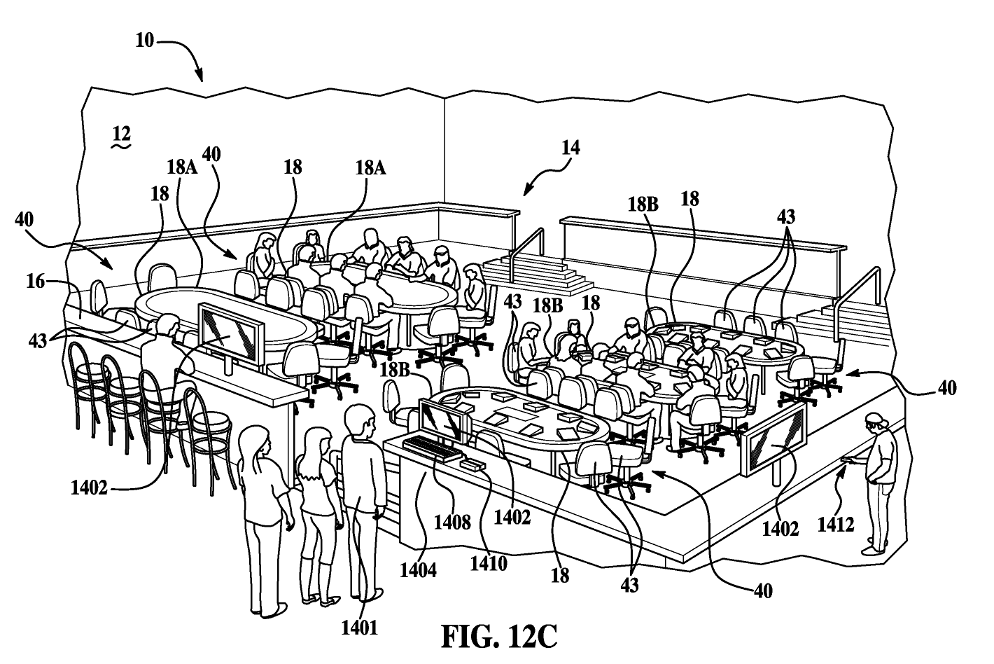

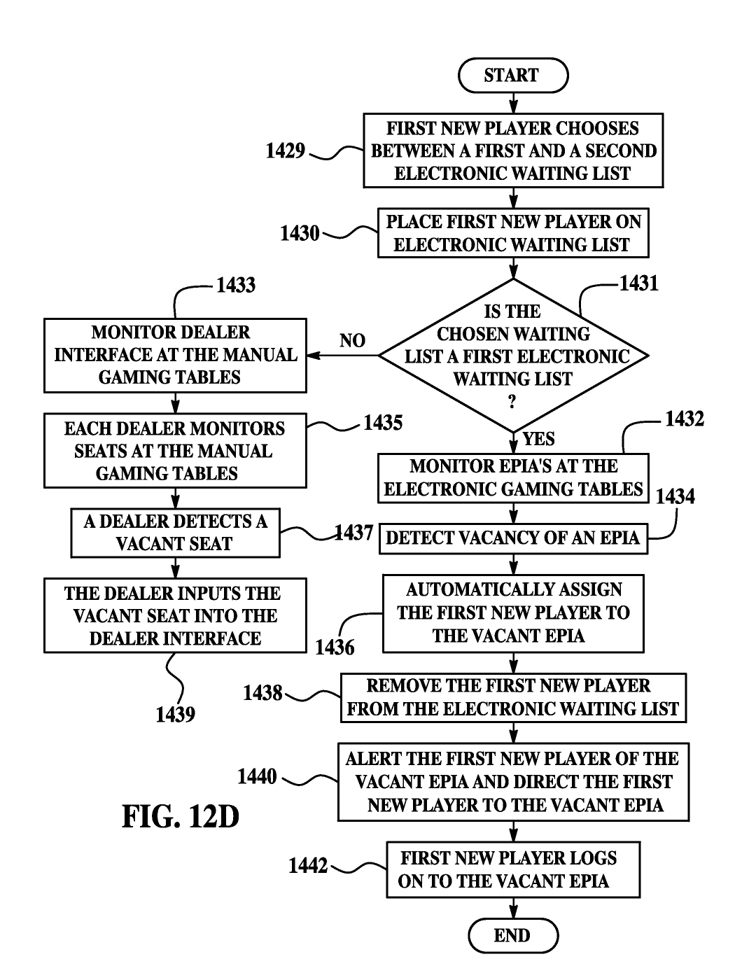

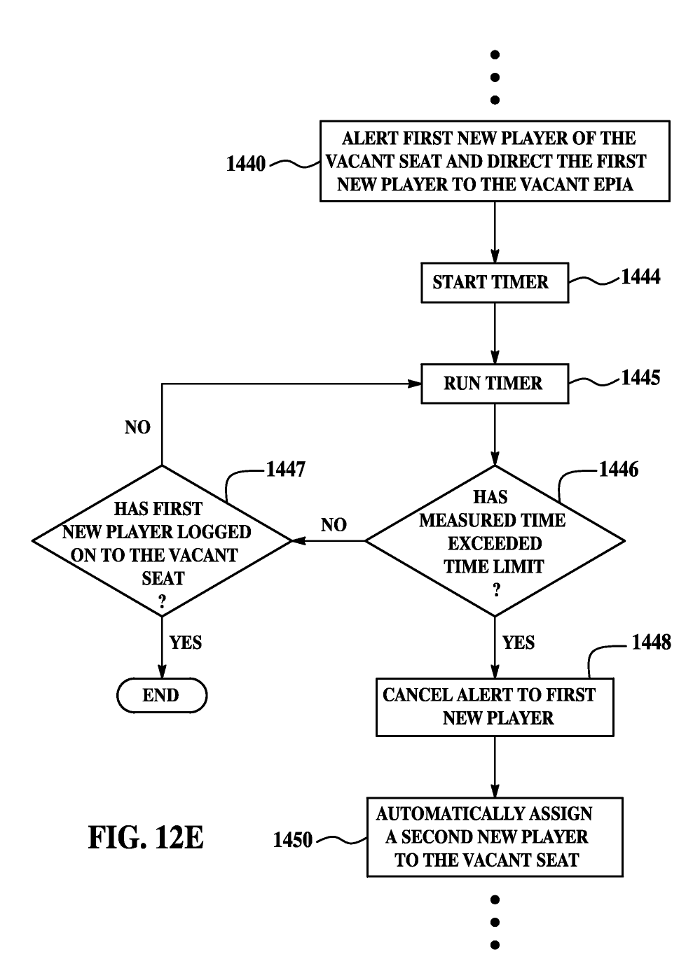

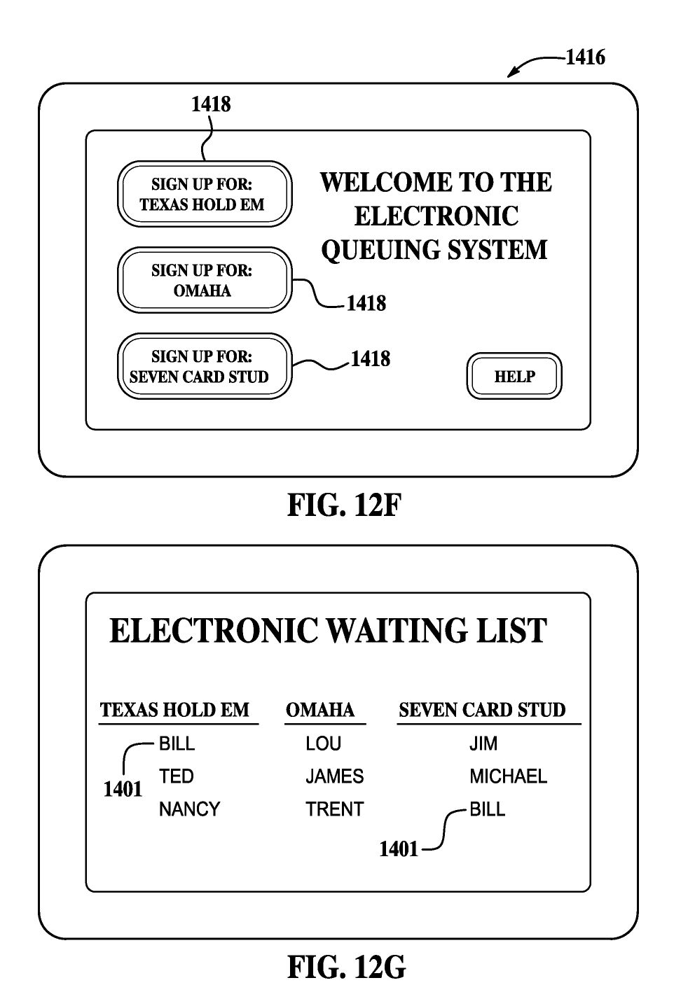

Referring to FIGS. 12A and 12B, a queuing system 1400 is provided to fill vacancies at the electronic and manual gaming tables 18 in the poker room 14 by establishing an electronic waiting list. As previously described, the poker room 14 may include multiple gaming tables 18 adapted for accommodating different poker game types, e.g., Texas Hold'Em, Omaha, Seven Card Stud, with different betting provisions, e.g., no limit, pot limit, 2/4, 10/20, etc. The queuing system 1400 may be adapted to establish electronic waiting lists for each of the poker game types provided. In addition, the queuing system 1400 may be adapted to establish separate electronic waiting lists for the manual and electronic gaming tables 18A, 18B. For example, a first electronic waiting list, for the electronic gaming table 18B, and a second electronic waiting list, for the manual gaming table 18A. In the embodiment shown, ten EPIAs 24A-24J are included at each of the seats 43 at the electronic poker tables 18B and ten seats 43 are included at each of the seats 43 at the manual poker tables 18A. At least one dealer interface 57 is provided at each of the manual gaming tables 18A for use by the dealer at the manual gaming table 18A. The dealer interface 57 for each manual gaming table 18A is networked to a server computer 50. The EPIAs 24A-24J which incorporate the player interface 54 and/or the dealer interface 57 may form part of the queuing system 1400 for the electronic poker tables 18B.

Referring to FIG. 9, the system 10 includes a network 84 including the server computer 50. The server computer 50 is networked to the player interface 54, the dealer interface 57, and a queue interface 1404. As discussed above, at the manual gaming tables 18A, the dealer may detect the vacant seat 43 and input the vacant seat 43 into the dealer interface 57. At both the manual and electronic gaming tables 18A, 18B, the server computer 50 is programmed for monitoring the plurality of seats 43 and automatically assigning a first new player to a vacant seat 43 when a vacancy is detected by the server computer 50. A display device 1402 displays the electronic waiting list for each of the plurality of game types. The server computer 50 is connected, or networked, to the plurality of seats 43 via the player interface 54 and the queue interface 1404 at the electronic gaming tables 18B. The server computer 50 is programmed to electronically monitor the plurality of seats 43, electronically detect a vacancy at one of the plurality of seats 43, and automatically and electronically assign the first new player 1401 to the vacant seats 43 upon detecting the vacancy. The server computer 50 is programmed to detect the vacant seat 43 by receiving an electronic signal transmitted by the player interface 54 or the dealer interface 57 of the vacant seat 43 to the server computer 50. The electronic signal may be, for example, generated when a player logs off their seats 43 via the player interface 54 or the dealer interface 57 or via the dealer logging the player off other their seat 43 via the dealer interface 57.

The queue interface 1404 is used by the player or the employee for placing the first new player on the electronic waiting list. The queue interface 1404 may also allow the user to bypass the electronic waiting list and assign another player to the vacant seat 43. The queue interface 1404 may include a computer terminal with an input device. Referring to FIG. 12C, the queue interface 1404 is shown as a computer with monitor 1404, keyboard 1408, and card reader 1410, for placing a first new player 1401 on the electronic waiting list. The queue interface 1404 may also include the card reader 1410 for reading an identification card, such as a player tracking card, of the first new player 1401. The card reader 1410 may be used to read an identification (ID) card such as a player tracking card, account card, or the like, of the first new player 1401. Likewise, the queue interface 1404 is used for processing a personal identification number (PIN) of the first new player 1401 in conjunction with reading the ID card. Other input devices known for identifying individuals could also be used, such as biometric scanners or radio frequency identification (RFID) devices. In further embodiments, the queue interface 1404 comprises a touch-screen kiosk, a web-based registration system, or a remote device 1411 or telephone registration system, for placing the first new player 1401 on the electronic waiting list.

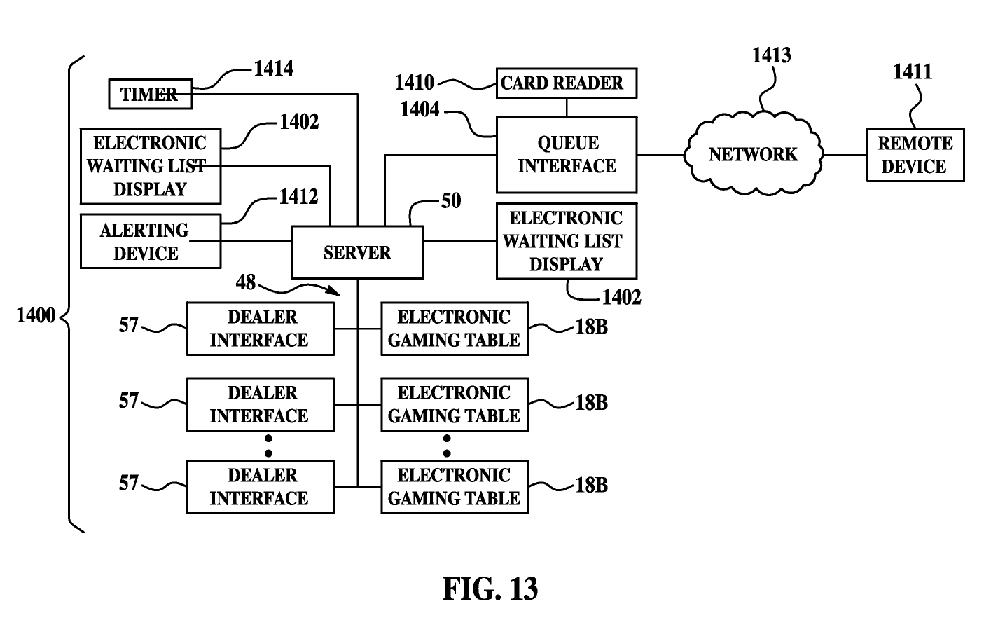

The remote device 1411 registration system would allow a user of a remote device 1411 to register for the electronic waiting list via a telephone or cell phone by dialing a telephone number or accessing the web. The user may additionally register for the electronic waiting list via a pager and send a text message. The first new player 1401 is allowed to select the electronic waiting list using the remote device 1411 and place their name on the electronic waiting list. The system may optionally be configured to allow the first new player to add their name to multiple waiting lists, such as the first and second electronic waiting lists. The system includes a queuing system for managing the electronic waiting list for filling a vacancy at one of the gaming tables 18. To do this, the remote device 1411 may be provided access to the electronic waiting list via a queue interface 1404 through a network 1413, as shown in FIG. 13. The network 1413 may be a cell phone network, a telephone network, an internet network, or any other network known to those skilled in the art for connecting a remote device 1411 to the queue interface 1404. The queue interface 1404 may comprise a computer. To identify the first new player to the computer or queue interface 1404 and gain access, the first new player may input a personal identification number (PIN) for processing by the computer. Alternatively, identification of the player may be accomplished by identification of the device, e.g., a telephone number. Additionally, a confirmation of the first new player being added to the electronic waiting list may be transmitted to the remote device 1411. When the first new player is on the electronic waiting list, the system monitors a plurality of seats at the gaming tables. When the system detects a vacancy at one of the gaming tables, the system may transmit an electronic signal corresponding to the vacancy to a network giving a server computer. The system may alert the first new player of the vacant seat via the remote device 1411. The alert to the remote device 1411 may be in the form of a phone call, a text message, an email message, a voicemail message, a buzzer, etc.

Multiple display devices 1402 may be used to display the electronic waiting lists. For example, a large display device may be displayed remotely. Additionally, the first new player 1401 may wish to log into the queue system 1400 and view those electronic waiting lists they are registered on and the status of the first new player 1401 with respect to other players also on the electronic waiting lists. The system may therefore allow the first new player 1401 to log on to a display device and select the first and/or second electronic waiting list for viewing on the display device. The status of the first new player 1401 would be displayed on the display device for the desired waiting list(s) or all of the waiting lists the first new player 1401 is registered to. This viewing would allow the first new player 1401 to see where they are positioned on the electronic waiting list(s) relative to the other new players, also registered on the waiting list(s). Optionally, a user, such as the dealer, may be allowed to bypass the electronic waiting list(s) and place another new player ahead of the first new player (or any other new player) on the electronic waiting list(s). The system monitors the plurality of seats 43 at the gaming tables 18 and when the system detects a vacancy, the next available new player is assigned from the waiting list to the vacant seat 43. When this happens, the next available new player who was assigned to the vacant seat 43 is removed from the electronic waiting list. For the assignment of the next available new player to take place, a electronic signal, corresponding to the vacancy, may be transmitted to the network having the server computer in response to detecting the vacancy. As new players are added and/or removed from the electronic waiting list, the electronic waiting list(s) may be updated on the display device. To do this, the display device is provided access to the queuing system for monitoring the status of the first new player 1401 is monitored with respect to the plurality of gaming tables 18.

An alerting device 1412 may be used to alert the first new player 1401 of the vacancy. The alerting device 1412 may include, but is not limited to, a display, a loudspeaker, a human host, a buzzer, a cell phone, a pager, any other remote device 1411, or any combination thereof. In FIG. 12A and 12B, the alerting device 1412 is in electronic communication with the server computer 50. In this instance, the alerting device 1412 may comprise a display that automatically displays a name or ID number of the first new player 1401, or the alerting device 1412 may be a buzzer electronically linked (e.g., wireless) to the server computer 50 with the buzzer vibrating or buzzing upon the server computer 50 detecting the vacancy and assigning the vacant seat 43 to the first new player 1401. The alerting device 1412 may additionally, be a wireless device, such as a cell phone or a pager. Additionally, an alert by the alerting device 1412 on the wireless device may be in the form of a text message, an email, or a voicemail message. Additionally, if the first new player has been placed on an electronic waiting list and is presently playing at another gaming table 18, the alert may be in via the wireless device, the EPIA 24A-24J, or both.

Still referring to FIGS. 12A and 12B, a timer 1414 may be used to measure a time period that starts upon alerting the first new player 1401 of the vacancy. In this instance, the first new player 1401 has a time limit in which to logon to the vacant seat 43 after being alerted of the vacancy. If the first new player 1401 does not logon within the time limit, the server computer 50 is programmed to re-assign the vacant seat 43 to a second new player on the electronic waiting list.

The server computer 50 may be programmed to monitor a plurality of game types, such as Texas Hold'em, 7 card stud poker, Omaha poker, and gaming table 18 types, such as manual gaming table 18A and electronic gaming table 18B. The queue interface 1404 may be adapted to place a plurality of new players on an electronic waiting list for each of the plurality of game types and/or gaming table 18. Multiple game types may be played in the same location, e.g., the poker room 14, or separate locations may be utilized for each game type. In any event, the queuing system 1400 may be capable of placing multiple new players on the electronic waiting lists for each of the game types. In FIG. 12C, the poker room 14 is shown with five poker tables 18 with only two of the poker tables 18 being utilized for gaming.

With reference to FIGS. 12D and 12E, the method of operation and use of the queuing system 1400 will now be described with respect to the first new player 1401. Initially, the poker room 14 is filled to capacity with current players. Each of the current players is required to logon to their respective seats 43 using the player interface 54 at the electronic gaming table 18B or the dealer interface 57 at the manual gaming table 18A. In effect, the current players logon to the network thereby transmitting an electronic signal to the server computer 50 that indicates that their seat 43 is occupied. By requiring each of the current players to logon in some capacity, the server computer 50 electronically monitors which seats 43 are occupied and which are vacant.

Referring again to FIG. 12D, the first new player 1401 is required to choose between the first and second electronic waiting list in STEP 1428. With each of the seats 43 being occupied by one of the current players, the first new player 1401 is placed on the selected electronic waiting list in STEP 1430. As discussed, this may be accomplished a number of ways, e.g., ID card reader 1410/entering PIN, biometric scanner, touch-screen kiosk, web-based registration, telephone, and the like. An example of the touch-screen kiosk is shown in FIG. 12G, in which the touch screen 1416 includes touch-selectable buttons 1418 for accessing three different electronic waiting lists, e.g., one for Texas Hold'em, one for Omaha, and one for Seven Card Stud. When any of these buttons 1418 are selected, the first new player 1401 is prompted to enter the information needed to place their name on the respective electronic waiting list. They may simply be prompted to pass their ID card through the card reader 1410 and/or enter their PIN, they may be prompted to scan a biometric, or they may be prompted to simply enter their name.

In one embodiment, the first new player 1401 may register on a plurality of electronic waiting lists to play the different game types. Additionally, the first new player 1401 may not have a preference as to which game and/or type of gaming table 18 and is willing to take the first seat which becomes available. In either case, the player is given the option of choosing which electronic waiting list or lists to be added to via the queue interface 1404, e.g., the manual or electronic gaming tables 18B in STEP 1431. The waiting lists may correspond to one or more electronic and/or manual waiting lists.

Referring back to FIG. 12D, if the player selected the first electronic waiting list for the electronic gaming table 18B, the queuing system 1400 then monitors the seats 43 via the player interface 54 in STEP 1432 to determine when one of the current players vacates their seats 43 (or if vacant seats 43 already exist). The vacancy may be detected in STEP 1434 by the server computer 50 when one of the plurality of current players logs off of their respective seat 43 using the player interface 54. This provides the vacant seat 43 for the first new player 1401. Essentially, the step of detecting the vacancy comprises the step of detecting the logoff. Once the logoff is detected, another electronic signal corresponding to the vacancy is transmitted to the server computer 50 from the player interface 54 of the vacant seat 43.

Referring again to FIG. 12D, if the player selected the second electronic waiting list for the manual gaming table 18A, the queuing system 1400 then monitors the seats 43 via the dealer interface 57 in STEP 1438 to determine when a player vacates their seat 43 (or if vacant seats 43 already exist). Each dealer monitors the seats at the respective manual gaming table 18A in STEP 1435. When seat 43 becomes vacant, the dealer detects a vacant seat 43 in STEP 1437. The dealer then inputs this vacant seat 43 into the dealer interface 57 in STEP 1439, e.g., by logging off the player who vacated the seat 43.

When this electronic signal is received by the server computer 50, the first new player 1401 is automatically assigned to the vacant seat 43 in STEP 1436. Once the vacant seat 43 is assigned, the first new player 1401 is removed from the electronic waiting list in STEP 1414 and then alerted of the vacancy in STEP 1440. As previously discussed, the alert may be in the form of a buzzer, a display, a loudspeaker, etc. Once located, the first new player 1401 may logon to the vacant seat 43 (or alternatively, the dealer may log the first new player 1401 onto the vacant seat 43) in STEP 1442. Of course, if the time limit discussed above is in effect, the first new player 1401 will be required to logon to the vacant seat 43 before the time limit expires. Otherwise, if the time limit expires, the queuing system 1400 will re-assign the vacant seat 43 to the second new player. This sequence of events is best shown in FIG. 12E. Referring to FIG. 12E, the timer 1414 begins and runs in STEPS 1444 and 1445 after alerting the first new player 1401 of the vacancy. In STEP 1446, the measured time is compared to the time limit, while simultaneously, in STEP 1447, the server computer 50 continuously monitors if the first new player 1401 has logged on to the vacant seat 43. If the time limit is exceeded, the alert to the first new player 1401 is canceled in STEP 1448, and the second new player is assigned to the vacant seat 43 in STEP 1450. In other embodiments, the time limit is measured between assigning the vacant seat 43 and the first new player 1401 logging on to the vacant seat 43.

Referring to FIGS. 12F and 12G, the first new player 1401 may be placed on a plurality of electronic waiting lists corresponding to a plurality of electronic game types. Here, the queuing system 1400 is adapted to recognize that the first new player 1401 is listed on multiple electronic waiting lists, and the first new player 1401 is only removed from the electronic waiting list which corresponds to the gaming table 18 to which the first new player 1401 is assigned. Therefore, the first new player 1401 may remain on each of the plurality of other electronic waiting lists after automatically assigning the first new player 1401 to the vacant seat 43. Referring specifically to FIG. 12G, the display devices 1402 can also be adapted to display each of the plurality of electronic waiting lists.

In a further embodiment of the queuing system 1400, the first new player 1401 may be a current player that is already logged on a seat at one of the gaming tables 18. In this instance, each of the player interfaces 54 are configured with the queuing interface 1404 to allow current players to place themselves on other electronic waiting lists for other game types and remain on them while playing at a current gaming table 18. However, the queuing system 1400 may be configured such that if the first new player 1401 is presently playing in a gaming tournament, such as a poker tournament, then they are prevented from placing themselves on the electronic waiting list for another gaming tournament and/or gaming table 18. However, once the present gaming tournament ends, the player is once again allowed to register for another gaming tournament or gaming table 18. To do this, the system 10 monitors the progress of the gaming tournaments and may send an electronic signal from a computer at the gaming table 18 to the server computer 50 when the gaming tournament has started and/or ended.

In a still further embodiment of the queuing system 1400, current players may also be given a preference to vacated seats 43 at their current gaming table 18B. One of the current players may exercise this preference by requesting a new seat 43 at their gaming table 18B through an option (not shown) displayed on their player interface 59 or the dealer interface 57. If the option is selected, when the server computer 50 detects a vacant seat 43 at their gaming table 18B, the current player is given a predetermined time limit, e.g., 60 seconds, in which to accept the vacant seat 43 at their electronic poker table 18B. After the 60 second delay, the vacant seat 43 is automatically assigned to the first new player 1401 on the electronic waiting list in accordance with the method set forth above.

In another embodiment of the present invention, the queue interface 1404 allows a user, such as an employee of the casino, e.g., a dealer, to bypass the electronic waiting list and assign another player to the vacant seat 43. The another player may be a preferred player, a VIP, a player who has a reservation, or other similar player.

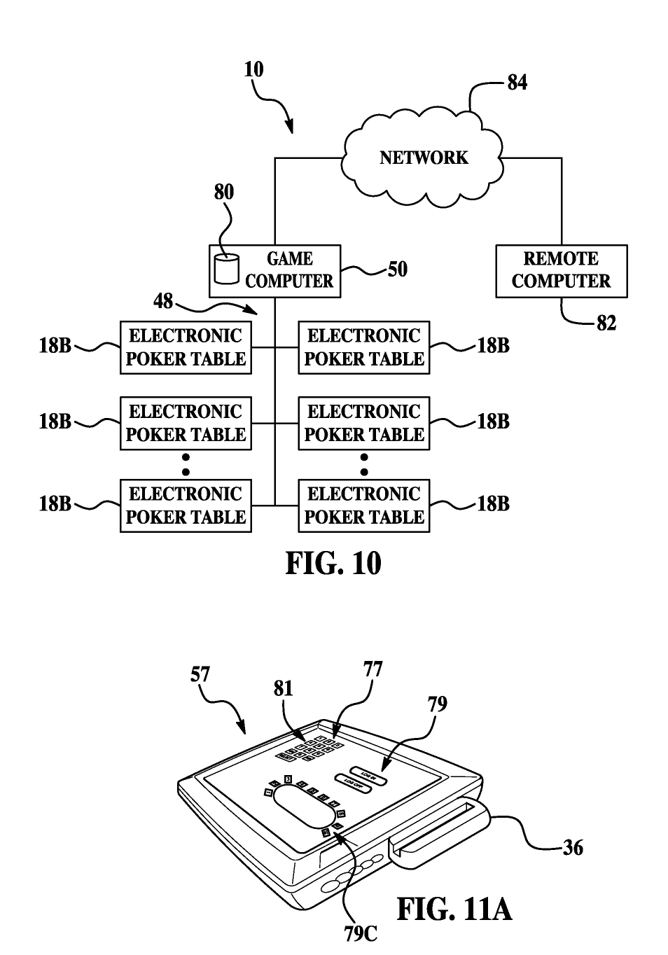

At the electronic gaming tables 18B, the system also includes a game computer 50 for administering a plurality of rounds of an electronic card game, as shown in FIG. 9. The game computer 50 may be in communication with the plurality of EPIAs 24 and the CDA computer 52, as shown in FIG. 9. The game computer 50 is responsible for facilitating player tracking, randomizing (i.e., “shuffling”) the electronic playing cards, “dealing” the electronic playing cards, handling and tracking wagers made by the players, receiving input from the players and responding accordingly, determining a winner of each round of the card game, distributes the pot, tracks the rake, etc. The game computer 50 may control the game at a single electronic gaming table 18B, as shown in FIG. 9, or the game computer 50 may control a plurality of electronic gaming tables 18B, as shown in FIG. 10. Other functions implemented by the game computer 50 are:
electronically shuffling the playing cards 76
dealing cards 28,30,
controlling players' turns,
receives the player's data input,
player tracking,
cashless wagering,
defining and modifying table parameters, including, turning the tables 18 on and off, setting the poker game being played at the table 18, setting wager parameters, and the like,
defining and managing jackpots, including the house percentage or rake,
defining and managing progressive jackpots,
establishing and managing a queue for players and assigning players to specific tables 18 from the queue, and
establishing and managing tournament play, including assigning player seats 43, collapsing tables, and the like.

A database 80 is in communication with the game computer 50. The database 80 can be integrated with the game computer 50. However, those skilled in the art realize that the database 80 may be separate from the game computer 50. The database 80 stores data representing the play of at least one round of the electronic card game. This data includes, but is not limited to, which cards are dealt to which player, which cards are the common or dealer cards, which cards are unused (i.e., undealt), how much is wagered in each series of wagering and the total round, which player was the “dealer”. each player's actions (call, raise, fold, etc.) during each round of the game, the time taken between actions, the winner of the round, the amount of the pot, and the amount of the rake. Of course, those skilled in the art realize other valuable data relating to the electronic card game which may be stored in the database 80.

As stated above, the identity of a player may be recorded when the player is playing at one of the electronic gaming tables 18. This identity may be stored in the database 80. Furthermore, the identity of the player may be associated with the rounds of the electronic card games in which the player participates.

Each round of the electronic card game may be subdivided into and defined by a plurality of actions. For example, theses actions may include, but are not limited to, opening wagers, dealing the face-down player's cards 76 to each player, a first player “checking”. a second player betting $50, a third player “calling”. the first player folding, dealing the first three common cards 30, the second player “checking”. and so on.

Obviously, many modifications and variations of the present invention are possible in light of the above teachings. The invention may be practiced otherwise than as specifically described within the scope of the appended claims.

What is claimed is:

1. A method of filling a vacancy at a gaming table with a first new player using a remote device, said method comprising the steps of:
managing an electronic waiting list for filling a vacancy at a gaming table;
allowing the first new player to select the electronic waiting list using the remote device; and
placing the first new player on the electronic waiting list for the gaming table via the remote device.

2. A method, as set forth in claim 1, including the step of providing the remote device access to the electronic waiting list via a queue interface.

3. A method, as set forth in claim 2, wherein the queue interface comprises a computer.

4. A method, as set forth in claim 2 including the step of processing a personal identification number (PIN) of the first new player by the computer for providing the remote device access to the electronic waiting list.

5. A method, as set forth in claim 1, including the step of transmitting a confirmation of the placement of the first new player on the electronic waiting list to the remote device.

6. A method, as set forth in claim 1, wherein said step of managing an electronic waiting list is further defined as the steps of managing a first electronic waiting list for filling a vacancy at a first gaming table and managing a second electronic waiting list for filling a vacancy at a second gaming table and said step of allowing the first new player to select the electronic waiting list is further defined as the step of allowing the first new player to select the first and second electronic waiting lists.

7. A method, as set forth in claim 1, further comprising the step of alerting the first new player of a vacant seat at the gaming table via the remote device.

8. A method, as set forth in claim 1, including the steps of:
monitoring a plurality of seats at the gaming table;
detecting a vacancy of one of the seats at the gaming table;
transmitting an electronic signal corresponding to the vacancy to a network having a server computer in response to detecting the vacancy.

9. A method, as set forth in claim 8, including the step of alerting the first new player of the vacant seat.

10. A method, as set forth in claim 9 wherein said step of alerting is further defined as the step of alerting the first new player of the vacant seat via the remote device.

11. A method, as set forth in claim 1, wherein the remote device is defined as a telephone.

12. A method, as set forth in claim 11, wherein the remote device is further defined as a cell phone.

13. A method, as set forth in claim 1, wherein the remote device is further defined as a pager.

14. A method, as set forth in claim 1, wherein said step of placing the first new player on the electronic waiting list via the remote device is further defined as the step of placing the first new player on the electronic waiting list for the gaming table via the web access from the remote device.

15. A method, as set forth in claim 1, wherein said step of placing the first new player on the electronic waiting list via the remote device is further defined as the step of placing the first new player on the electronic waiting list for the gaming table on the remote device by dialing a telephone number.

16. A method, as set forth in claim 1, wherein said step of placing the first new player on the electronic waiting list via the remote device is further defined as the step of placing the first new player on the electronic waiting list for the gaming table by sending a text message from the remote device.

17. A method, as set forth in claim 1, including the step of providing a network for interconnecting the remote device and the queue interface.

18. A system for filling a vacancy at a gaming table with a first new player, said system comprising:
a plurality of seats for use by a plurality of current players at the gaming table;
a queuing system for managing a first electronic waiting list for filling the vacancy at the gaming table; and
a queue interface for providing the first new player access to the queuing system via a telephone to place the first new player on the first electronic waiting list.

19. A system, as set forth in claim 18, wherein the queue interface further includes a computer.

20. A system, as set forth in claim 18, including a network interconnecting the remote device and the queue interface.

21. A method of filling a vacancy at a gaming table with a first new player, said method comprising the steps of:
managing a first electronic waiting list for filling a vacancy at a first plurality of gaming tables;
managing a second electronic waiting list for filling a vacancy at a second plurality of gaming tables;
providing the remote device access to the electronic waiting list via a queue interface;
allowing the first new player to select one of the first and second electronic waiting lists using the remote device; and
placing the first new player on the selected one of the first and second electronic waiting lists via the remote device.
